(19) United States
(12) Patent Application Publication
(10) Pub. No.: US 2010/0028500 A1
(43) Pub. Date: Feb. 4, 2010

(54) Article of manufacture for packaging edible liquid and solid components together and process for making same

(76) Inventor: William Towne Sander, Vernon, CA (US)

Correspondence Address: HARRY V. MCGAHEY JR., 1532 SIXTH AVENUE, SAN DIEGO, CA, 92101, US

(21) Appl. No.: 12/184,859

(22) Filed: Aug. 1, 2008

(51) Int. Cl. A23C 9/123; B65B 25/22

(52) U.S. Cl. 426/130; 426/106; 426/392

(57) ABSTRACT

An article of manufacture for packaging edible liquid and solid components together comprised of a container, a base product comprised of a moist based ingredient in the bottom of the container, the base product covered by an edible sealing layer, the partially filled container being passed through a cooler to cause the sealing layer to become firm enough to support a dry component, the dry component deposited on top of the sealing layer, and a sealing means to seal the container.

### CROSS REFERENCE TO RELATED APPLICATIONS

Not Applicable

### STATEMENT REGARDING FEDERALLY SPONSORED RESEARCH OF DEVELOPMENT

Not Applicable

### DESCRIPTION OF ATTACHED APPENDIX

Not Applicable

### BACKGROUND OF THE INVENTION

This invention relates generally to the field of food packaging and more specifically to an article of manufacture for packaging edible liquid and solid components together and process for making same.

Consumer preferences in the premium and natural foods segments of consumer food products have been built on maintaining the integral texture and flavor of key recipe components. Preferably, they are presented in a form that is as close to their naturally occurring state as possible.

The preferred embodiment of the process therefore is a process comprising the following steps:

selecting a container;

obtaining a base product comprised of a moist base ingredient;

placing the base product in the bottom of the container;

sealing the base product in the container by depositing an edible sealing layer on top of the base product;

passing the partially filled container through a cooler to cause the sealing layer to become firm enough to support a dry or semi-moist top layer;

depositing a dry or semi moist component on top of the sealing layer; and sealing the container.

The sealing of the base product is unique in that gelatin is mixed with a liquid form of the base product which, in turn, is used as the sealing layer. Gelatin has been used in some packaging to inhibit mold growth, but not specifically for packaging like this invention.

Relevant art includes the following:

U.S. Pat. No. 6,395,320 (May 28, 2002 Hazell) discloses an invention comprised of two component packaged food products. They may either be directly in contact with each other or separated by a specified edible interfacial layer. The edible layer possibilities mentioned in the specification do not include gelatin.

U.S. Pat. No. 6,176,375 (Jan. 23, 2001 Truscello et al.) is for a container with a hollow base to store a filled food product having an edible shell with a peripheral flange.

U.S. Pat. No. 5,518,744 (May 21, 1996 Kaeser et al.) is a packaged food combination with an edible fatty barrier.

U.S. Pat. No. 5,194,274 (Mar. 16, 1993 Oda) is an ice confectionary having a layer of crushed ice particles impregnated with syrup.

U.S. Pat. No. 4,874,618 (Oct. 17, 1989 Seaborne et al.) and U.S. Pat. No. 4,820,533 (Arp. 11, 1989 Seaborne et al.) disclose a package containing a moisture resistant edible internal barrier. A number of examples of compositions for edible internal barriers are given but gelatin is not one of them.

U.S. Pat. No. 4,318,935 (Mar. 09, 1982 Stussi) and U.S. Pat. No. 4,225,623 (Sep. 30, 1980 Stussi) describe a commercial method for filling containers with a base food product that itself supports a topping located immediately inside a lid sealed to the top of the container. An intermediate layer of gelatin or gelatin matrix is not an integral part of this invention. The sealing barrier is comprised of a water-insoluble material such as a relatively high melting point vegetable oil, such as hydrogenated coconut oil, or hydrogenated animal fat.

U.S. Pat. No. 3,411,921 (Nov. 19, 1968 Shifrin) is a method of making a food package wherein the bottom of a container is filled about 30% of the volume with strawberries. A water solution of gelatin is made and then poured on the surface to solidify the package. There is no sealing barrier such as in the subject invention.

U.S. Pat. No. 2,714,070 (Jul. 26, 1955 Welch) is a method of microwaving and heating a food package.

Food products for health conscious consumers preferably do not contain any trans-fats and minimize all fat content. Also, when packaging food, the packaging content of a product should be minimized and should be recyclable from an economic and environmental perspective. Current packaging methods do not adequately address these problems.

Current packaging for fruit and yogurt, and similar edibles, present a homogenous blend of processed fruit and yogurt. Packaging methods use plastic, foil or cellophane barriers and lids which are not necesarily biodegradable or recyclable, resulting in increased trash that has to be disposed of in landfills. The distinctive flavors and textures of the different components are lost in the situation where the components come pre-mixed together. Consumers consistently prefer separate rather than mixed together flavors.

The invention herein described presents any number of key ingredients, which are significantly different in moisture content, color, flavor and texture, independently in a single recyclable container. All of the components are ready to combine (blend) and eat without the need to transfer the food into another container for consumption.

The advantage of the subject process is that the components are maintained and presented independently, separated by a matrix with a popular, edible food product (Gelatin & the base component) in a fully recyclable container. As a result, the cost of packaging is minimized and the packaging is environmentally friendly. This is accomplished without the use of fats or other undesirable ingredients. The flavor is kept separate and fresher. The texture of the fruit and yogurt stays in their pure form. The fruit does not get soggy, the yogurt does not get watery. Each maintains its original texture and flavor. This method of packaging delivers fruit in a more natural, unprocessed form which is more desirable to many consumers. No additives are required to be added to the fruit for preservation. All ingredients are kept in their distinct original form. It minimizes the packaging associated with the final product

### BRIEF SUMMARY OF THE INVENTION

The primary object of the invention is to provide a better method of packaging fruit and yogurt together. Another object of the invention is to avoid the need to use fats or other undesirable ingredients or packaging material to keep product components separated. Another object of the invention is to provide a better method of packaging food when it is desirable to keep a liquid based ingredient separate from a solid component such as fruit. Another object of the invention is to provide a better way of packaging moist and dry edible components together. A further object of the invention is to provide a better method of manufacture for packaging which keeps the flavor of the components separate and fresher until consumption. Yet another object of the invention is to provide a better method of manufacture for packaging for food in which the flavor is kept separate and fresher. Still yet another object of the invention is to provide a better method of manufacture for packaging for fruit and yogurt together in which the texture of the fruit and yogurt stays in their pure form. Another object of the invention is to provide a better method of manufacture for packaging for fruit and yogurt together in which the fruit does not become soggy and the yogurt does not become watery. Another object of the invention is to provide a better method of manufacture for packaging for food in which each packaged component maintains its original texture and flavor. A further object of the invention is to provide a better method of manufacture for packaging for fruit which delivers fruit in a more natural, unprocessed form which is more desirable to many consumers. Yet another object of the invention is to provide a better method of manufacture for packaging for fruit in which no additives are required to be added to the fruit for preservation. Still yet another object of the invention is to provide a better method of manufacture for packaging for food in which all ingredients are kept in their distinct original form. Another object of the invention is to provide a better method of manufacture for packaging for food which minimizes the packaging associated with the final product. Another object of the invention is to provide a better method of manufacture for packaging for food which is very “Green”. A further object of the invention is to provide a better method of manufacture for packaging for food which consumers prefer over current methods of food packaging.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for packaging edible liquid and solid components together comprising: a container, a base product comprised of a moist based ingredient, the base product placed in the bottom of the container, the base product covered by an edible sealing layer, a dry component, the partially filled container being passed through a cooler to cause the sealing layer to become firm enough to support the dry component, the dry component deposited on top of the sealing layer, and a sealing means to seal the container.

In accordance with a preferred embodiment of the invention, there is disclosed a process for packaging edible liquid and solid components together comprising the steps of: selecting a container, obtaining a base product comprised of a moist based ingredient, placing the base product in the bottom of the container, sealing the base product in the container by depositing an edible sealing layer on top of the base product, passing the partially filled container through a cooler to cause the sealing layer to become firm enough to support the dry product, depositing a dry component on top of the sealing layer, and sealing the container.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention with the first layer of moist based ingredient in place.

FIG. 2 is a perspective view of the invention with the impervious sealing layer in place.

FIG. 3 is a perspective view of the invention with the dry ingredients in place and sealed with a lid.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

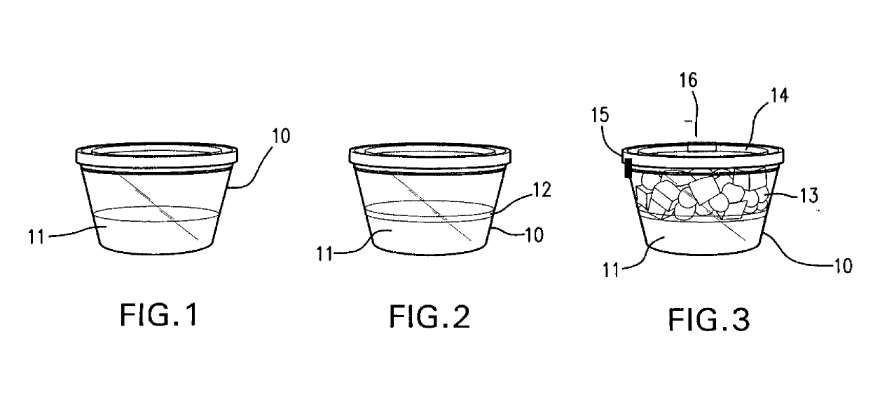

In accordance with the present invention, FIG. 1 shows a perspective view of the article of manufacture with the first layer of moist based ingredient in place. A moist base product (11) component such as yogurt, custard, an edible sauce, etc is deposited into the bottom of a recyclable container (10). In the preferred embodiment, the base product is comprised of 4 ounces of regular or nonfat yogurt, but it can be any edible moist product.

FIG. 2 is a perspective view of the invention with the impervious layer in place. The base product (11) inside the recyclable container (10) is sealed by depositing an edible sealing layer (12) comprised of a modified form of the base product (11), which is flavored to complement the other components. The product, at this point is placed in or passed through a cooler to cause the sealing layer to become firm enough to support the semi-moist or dry ingredients by being cooled. The sealing layer(12) has now covered the base product (11). In the preferred embodiment, the sealing layer is comprised of a mixture of yogurt and gelatin in a ratio of 8.3 to 1 of yogurt to gelatin and the sealing layer is ¼± 1/16 inches thick. Also, the cooler temperature is kept at approximately 36 degrees fahrenheidt and the partially filled container is in the cooler to set the sealing layer for approximately 7 minutes. However, any cooling parameters of temperature and time which set the sealing layer sufficiently firm will work.

FIG. 3 is a perspective view of the invention with the dry ingredients in place. After the sealing layer (12) has been solidified over the base product (11), a semi-moist or dry component (13), such as diced fruit, vegetable pieces, granola, cereal, etc are deposited on top of the sealing layer (12). The product is then sealed with a lid (14). Finally, a tamper evident device (15) and coding label (16) are applied to the sealed container (10) which is then packed for shipment and sale. Any sealing means could be used which will provide the necessary sanitatary preservation until the package is consumed. The container can also be sealed with a flexible plastic film or even a cardboard lid. In the preferred embodiment, the dry component is comprised of 5 ounces of ⅜ inch chunks of diced fruit. However granola, cereal, or pieces of vegetable can also be used for the edible semi-moist or dry component which is placed on top of the sealing layer.

For the preferred embodiment of this packaging process, which is for the sale of fresh fruit and yogurt together, the yogurt is placed first into a cup or container as the base product (11); then the edible seal (12) is placed on top of the yogurt; then the dry component (13) such as diced fruit is placed on top of the yogurt so the flavor of the fruit is kept separate and fresher. Finally a seal is placed over all three of the ingredients.

In the preferred embodiment, 4 ounces of non-fat, vanilla flavored yogurt is used as the base product (11), 0.7 ounces of nonfat vanilla flavored yogurt mixed with gelatin so as to provide a sealing layer (12), and 5 ounces of ⅜ inch diced fruit in chunks is used for the dry component (13).

The preferred embodiment of the edible seal is a mixture of the base product (11) with gelatin. Specifically clear, unflavored, sweetened gelatin. In the preferred embodiment, the sealing layer is comprised of a mixture of yogurt and gelatin in a ratio of 8.3 to 1 of yogurt to gelatin. The preferred depth of the sealing layer is between ¼ +or − 1/16 inch thick. However the sealing layer may be comprised of a modified form of any base product so as to form an impervious barrier, so long as it is compatible with mixing with gelatin.

The preferred embodiment of the process therefore is a process comprising following steps;

selecting a container;

obtaining a base product comprised of a moist based ingredient;

placing the base product in the bottom of the container;

sealing the base product in the container by depositing an edible sealing layer comprised of a mixture of gelatin and the base product on top of the base product;

passing the partially filled container through a cooler to cause the sealing layer to become firm enough to support the base product;

depositing a dry component on top of the sealing layer; and

sealing the container.

The preferred cooling process is comprised of keeping the cooler temperature at approximately 36 degrees fahrenheit when the partially filled container is in the cooler. The preferred process is to keep the partially filled container in the cooler to set the sealing layer for approximately 7 minutes. However any similar cooling protocol which sets the gelatin mixture will work. The partially filled container can be passed through the cooler on a continuous conveyor belt system or be placed in a cooler in batches.

To use, a consumer opens the container and stirs the fruit into the yogurt. The gelatin and base product mixture homogenizes with the yogurt. Then it is consumed.

Another embodiment would be to use the process wherein granola is placed on top of the fruit, maintaining both component's texture.

One could also separate fruit and other types of toppings, such as non-dairy whip cream, or cereal and a topping, or any such combination. This system could be used any place a moist base ingredient is kept separate from the solid components like fruits, cereals, sour cream, or whipped cream. In addition, other more traditional meals could use this system, for example vegetables and sauces and/or garnishes could also be possible applications (such as broccoli and cheese sauce almondine)

The current preferred embodiment uses about ¼ inch of the gelatin-base product mixture. In use the package should have as little sealer as possible, but should be an amount sufficient to maintain separation between the components during handling. Other preferred embodiments use a sealing layer between ⅛ and ½ inches thick before the container is passed through the cooler.

Also the edible seal that was impervious to moisture can be blendable with the yogurt. Any place a liquid based ingredient is kept separate from the solid components like fruits, cereals, sour cream, whipped cream this process could be useful.

After the manufacturing process, the preferred method is to apply a tamper evident device and date code to the sealed container.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims. While the preferred embodiment described is a 9 to 10 ounce single serving product, the invention can be used to produce products ranging from 6 ounce single servings to 5 to 10 pound or larger multiple serving containers.

What is claimed is:

1. An article of manufacture for packaging edible liquid and solid components together comprising:
a recyclable container;
a base product comprised of a moist base ingredient;
the base product placed in the bottom of the container;
the base product covered by an edible sealing layer comprised of a mixture of gelatin and the base product;
a dry component:
the partially filled container being cooled sufficiently to cause the sealing layer to become firm enough to support the dry component;
the dry component deposited on top of the sealing layer; and
a sealing means to seal the container.

2. An article of manufacture for packaging edible liquid and solid components together as claimed in claim 1 wherein the container is reusable.

3. An article of manufacture for packaging edible liquid and solid components together as claimed in claim 1 wherein the base product is comprised of yogurt.

4. An article of manufacture for packaging edible liquid and solid components together as claimed in claim 1 wherein the sealing layer is flavored to complement the other components in the container.

5. An article of manufacture for packaging edible liquid and solid components together as claimed in claim 1 wherein the sealing layer is comprised of a mixture of yogurt and gelatin.

6. An article of manufacture for packaging edible liquid and solid components together as claimed in claim 10 wherein the sealing layer is comprised of a mixture of yogurt and gelatin in a ratio of 8.3 to 1 of yogurt to gelatin.

7. An article of manufacture for packaging edible liquid and solid components together as claimed in claim 1 wherein the sealing layer is ¼± 1/16 inches thick.

8. An article of manufacture for packaging edible liquid and solid components together as claimed in claim 1 wherein the sealing layer is comprised of gelatin only.

9. An article of manufacture for packaging edible liquid and solid components together as claimed in claim 1 wherein the cooler temperature is kept at approximately 36 degrees fahrenheidt and the partially filled container is in the cooler to set the sealing layer for approximately 7 minutes.

10. An article of manufacture for packaging edible liquid and solid components together as claimed in claim 1 wherein the dry component is comprised of diced fruit.

11. An article of manufacture for packaging edible liquid and solid components together as claimed in claim 1 wherein the dry component is comprised of 5 ounces of ⅜ inch chunks of diced fruit.

12. An article of manufacture for packaging edible liquid and solid components together as claimed in claim 1 wherein the dry component is comprised of pieces of vegetable.

13. An article of manufacture for packaging edible liquid and solid components together as claimed in claim 1 wherein the container is sealed with a flexible plastic film, or other closure device.

14. An article of manufacture for packaging edible liquid and solid components together as claimed in claim 1 wherein a date code is applied to the sealed container.

15. A process for packaging edible liquid and solid components together comprising the steps of:
selecting a container;
obtaining a base product comprised of a moist based ingredient;
placing the base product in the bottom of the container;
sealing the base product in the container by depositing an edible sealing layer on top of the base product;
passing the partially filled container through a cooler to cause the sealing layer to become firm enough to support the base product;
depositing a dry component on top of the sealing layer; and
sealing the container.

16. A process for packaging edible liquid and solid components together as claimed in claim 15 wherein the sealing layer is ¼± 1/16 inches thick before the container is passed through the cooler.

17. A process for packaging edible liquid and solid components together as claimed in claim 15 wherein the sealing layer deposited on top of the base product is comprised of gelatin.

18. A process for packaging edible liquid and solid components together as claimed in claim 15 wherein the cooler temperature is kept at approximately 36 degrees fahrenheidt when passing the partially filled container through a cooler and is in the cooler to set the sealing layer for approximately 7 minutes.

19. A process for packaging edible liquid and solid components together as claimed in claim 15 wherein the dry component is comprised of 5 ounces of approximately ⅜ inch chunks of diced fruit.
